(19) United States
(12) Patent Application Publication
(10) Pub. No.: US 2007/0198448 A1
(43) Pub. Date: Aug. 23, 2007

(54) Scalable ontology reasoning

(75) Inventors: Achille Fokoue-Nkoutche, White Plains, NY (US); Aaron Kershenbaum, New City, NY (US); Kavitha Srinivas, Rye, NY (US)

Correspondence Address: MICHAEL J. BUCHENHORNER, 8540 S.W. 83 STREET, MIAMI, FL, 33143, US

(73) Assignee: International Business Machines Corporation

(21) Appl. No.: 11/358,367

(22) Filed: Feb. 21, 2006

(51) Int. Cl. G06N 5/00

(52) U.S. Cl. 706/45

(57) ABSTRACT

Methods and apparatus, including computer program products, for scalable ontology reasoning. A method of generating a summarized ontology includes loading an ontology from a store, eliminating relationships in the ontology, the eliminating relationships including an insertion of new relationships that simplify the ontology, eliminating individuals in the ontology, the eliminating individuals including insertion of new individuals to simplify the ontology, eliminating concepts in the ontology including insertion of new concepts to simplify the ontology, and generating the summarized ontology from the eliminating relationships, eliminating individuals and eliminating concepts.

### BACKGROUND

The present invention relates to data processing by digital computer, and more particularly to scalable ontology reasoning.

In recent years the development of ontologies—explicit formal specifications of the terms in the domain and relations among them—has been moving from the realm of Artificial-Intelligence laboratories to the desktops of domain experts. Ontologies have become common on the World-Wide Web. The ontologies on the Web range from large taxonomies categorizing Web sites (such as on Yahoo!) to categorizations of products for sale and their features (such as on Amazon).

An ontology defines a common vocabulary for researchers who need to share information in a domain. It includes machine-interpretable definitions of basic concepts in the domain and relations among them.

### SUMMARY

The present invention provides methods and apparatus, including computer program products, for scalable ontology reasoning.

In one aspect, the invention features an apparatus including an import module, a scope definition module, a query processing component, a storage manager, a reasoning engine, and a data store.

In embodiments, the import module can enable an import of OWL Web Ontology Documents into a persistent store that a reasoner relies on for data. The scope definition module can enable a user to specify a sub-part of an ontology. The query processing component can enable a parsing of queries expressed in SPARQL, a standardized query language for resource description framework (RDF) data. The storage manager can enable create, read, update, delete (CRUD) plus passing through reasoning functions.

The reasoning engine can include a taxonomy builder that infers implicit subclass and equivalence relationships between concepts, a consistency detection component that discovers any inconsistencies in an ontology, a relationship query component that answers questions about a relationship between ABox instances, and a membership query component that answers about types of various individuals.

The data store can be a RDF store.

In another aspect, the invention features a computer-implemented method of generating a simplified ontology including loading an ontology from a store, eliminating relationships in the ontology, the eliminating relationships including an insertion of new relationships that simplify the ontology, eliminating individuals in the ontology, eliminating individuals including insertion of new individuals to simplify the ontology, eliminating concepts in the ontology, and generating the simplified ontology from the eliminating relationships, eliminating individuals and eliminating concepts.

In embodiments, the method can include generating an explanation to a user of how a specific inference is made by an ontology reasoner. The method can include compressing the ontology with the simplified ontology. The compressed ontology can track changes in the ontology.

The ontology can include OWL Web Ontology Language documents.

The method can include receiving a query, and determining a response to the query in conjunction with the simplified ontology.

The invention can be implemented to realize one or more of the following advantages.

A simplified ontology can be used for the purposes of explaining to a user how a specific inference was made by an ontology reasoner. Because the summarized graphs are succinct, it is easier for the user to determine how an inference was made rather than within the context of the larger ontology.

A simplified ontology can be used for compressing the ontology, and using this compressed ontology to keep up with any changes in the ontology. This addresses an important problem for ontology reasoners, i.e., how to handle reason over changes in the ontology without having to re-inference over the entire ontology.

One implementation of the invention provides all of the above advantages.

Other features and advantages of the invention are apparent from the following description, and from the claims.

### BRIEF DESCRIPTION OF THE DRAWINGS

FIG. 1 is block diagram of an exemplary architecture.

FIG. 2 is an exemplary domain.

Like reference numbers and designations in the various drawings indicate like

### DETAILED DESCRIPTION

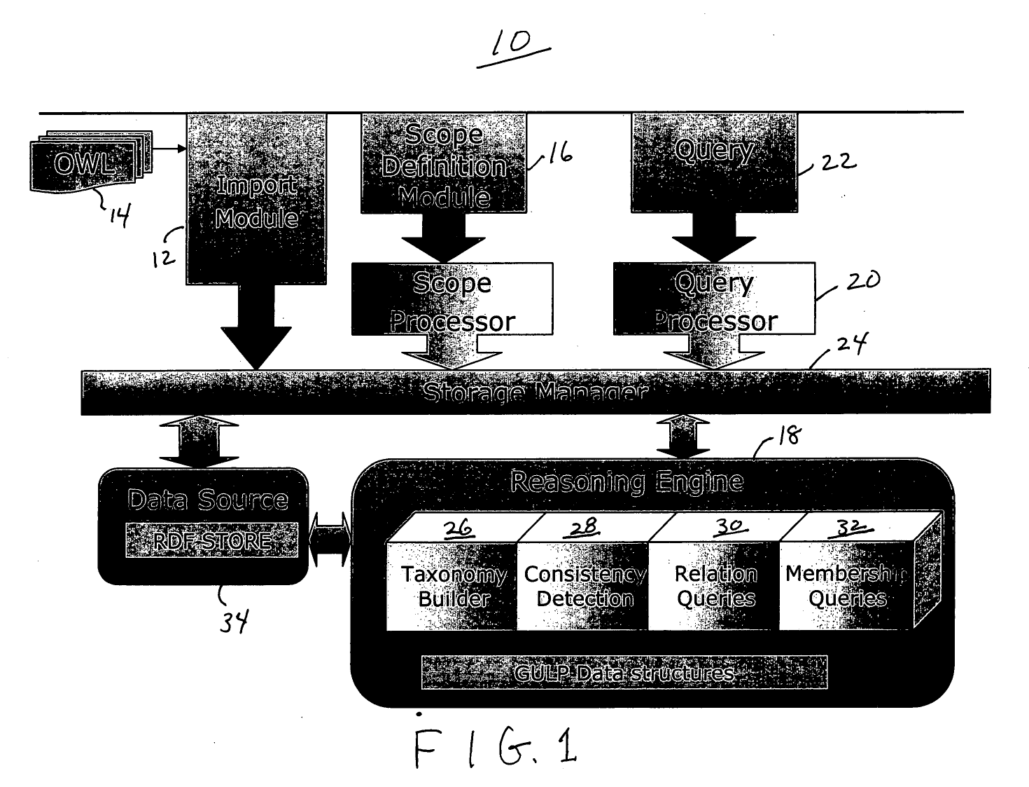

As shown in FIG. 1, an architecture 10 includes an import module 12. The import module 12 enables an import of OWL Web Ontology Documents 14 into a persistent store that the reasoner relies on for data.

The architecture 10 includes a scope definition module 16 that enables the user to specify a sub-part of the ontology (if the ontology is modular), which is useful for scalability. For instance, a biologist interested in the cellular function portion of the GO ontology may define only a sub-portion of the GO ontology as being relevant to the scope. This helps in scaling a reasoning engine 18.

The architecture 10 includes a query processing component 20 that enables the parsing of queries 22 expressed in SPARQL, a standardized query language for RDF data. SPARQL has limited expressiveness (e.g., you cannot express additional assertions, or express cardinality constraints on a relation unless it is already specified as a constraint in the TBox), nor is there a mechanism to express a consistency query.

The architecture 10 includes a storage manager 24 that is create, read, update, delete (CRUD) plus passing through reasoning functions.

The architecture 10 includes the reasoning engine 18. The reasoning engine 18 includes a taxonomy builder 26 that infers implicit subclass and equivalence relationships between concepts.

The reasoning engine 18 includes a consistency detection component 28, which discovers any inconsistencies in the ontology.

The reasoning engine 18 includes a relationship query component 30, which answers questions about the relationship between ABox instances.

The reasoning engine 18 includes a membership query component 32 that answers about the types of various individuals.

The architecture 10 includes a data store 34 that is a RDF store.

Artificial-Intelligence literature contains many definitions of an ontology; many of these contradict one another. For our purposes, an ontology is a formal explicit description of concepts in a domain of discourse (classes (sometimes called concepts)), properties of each concept describing various features and attributes of the concept (slots (sometimes called roles or properties)), and restrictions on slots (facets (sometimes called role restrictions)). An ontology together with a set of individual instances of classes constitutes a knowledge base. In reality, there is a fine line where the ontology ends and the knowledge base begins.

Classes are the focus of most ontologies. Classes describe concepts in the domain. For example, a class of wines represents all wines. Specific wines are instances of this class. The Bordeaux wine in the glass in front of you while you read this document is an instance of the class of Bordeaux wines. A class can have subclasses that represent concepts that are more specific than the superclass. For example, we can divide the class of all wines into red, white, and rose wines. Alternatively, we can divide a class of all wines into sparkling and non-sparkling wines.

Slots describe properties of classes and instances: Château Lafite Rothschild Pauillac wine has a full body; it is produced by the Château Lafite Rothschild winery. We have two slots describing the wine in this example: the slot body with the value full and the slot maker with the value Château Lafite Rothschild winery. At the class level, we can say that instances of the class Wine will have slots describing their flavor, body, sugar level, the maker of the wine and so on.

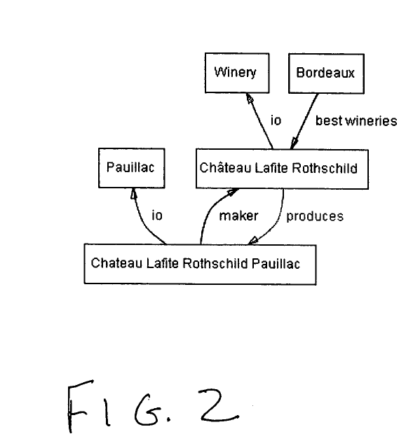

As shown in FIG. 2, all instances of the class Wine, and its subclass Pauillac, have a slot maker the value of which is an instance of the class Winery. All instances of the class Winery have a slot produces that refers to all the wines (instances of the class Wine and its subclasses) that the winery produces.

In practical terms, developing an ontology includes defining classes in the ontology, arranging the classes in a taxonomic (subclass-superclass) hierarchy, defining slots and describing allowed values for these slots, and filling in the values for slots for instances.

We can then generate a knowledge base by defining individual instances of these classes filling in specific slot value information and additional slot restrictions.

Description Logic (DL) ontologies can be divided conceptually into two components: a Thox and an ABox. The Thox contains assertions about concepts or roles. The Abox contains role assertions between individuals and membership assertions. We describe various static analyses that can be applied in order to simplify an ABox graph on which a consistency check is to be performed. These simplifications are essentially edge removals (i.e., removing relationships that are irrelevant for reasoning for inconsistency detection) in order to reduce the size of the graph and to break it into non-connected sub-graphs that can be processed separately.

Two kinds of analyses are described. First, pure T-RBox analyses only analyze concepts and roles defined in the TBox and RBox. They show that all edges in the ABox graph labeled with a given role are irrelevant for reasoning purpose.

Second, ABox analyses take into account the particular structure of a given ABox graph in order to discard more edges.

In both cases, the correctness of the analysis is established by showing that the original ABox is consistent if the modified ABox is consistent.

The description logic considered herein is OWL DL without nominals. For simplicity, we do not consider inverse functional properties. They can be dealt with by defining their inverse property as being a functional property. Furthermore, a cardinality restriction (e.g. cardinality(n, S)) is replaced by a maximum and a minimum cardinality restrictions with the same numeric value (=n S-->[n S 6 μnS).

ABox Preprocessing

The static analyses described here assume that the consistency check is done on the ABox obtained after applying some preprocessing actions:

(1) If the domain of a role S is A and R(a, b) is in the Abox and R β S then a: A (i.e. a is an instance of A) is added to the ABox if it was not already present.

(2) If the range of a role S is B and R(a, b) is in the ABox and R β S then b: B (i.e. b is an instance of B) is added to the ABox if it was not already present (3) If the domain of a role S is A and R(a, b) is in the Abox and R has an inverse R′ such that R′ β S then b: A (i.e. b is an instance of A) is added to the ABox if it was not already present.

(4) If the range of a role S is B and R(a, b) is in the ABox and R has an inverse R′ such that R′ β S then a: B (i.e. a is an instance of B) is added to the ABox if it was not already present.

The correctness of the analyses described herein not guaranteed if these four actions are not performed before removing edges.

The following two preprocessing actions are recommended, but not required:

(1) Nodes that are asserted to be identical are merged.

(2) If there exists three individuals a, b, c such that a is related to b and c through some functional property R (i.e. R(a, b) and R(a, c)) then b and c are merged.

Pure T-RBox Analyses

Intuitively, an edge labeled R in the ABox is relevant for consistency check if, during the reasoning (more precisely during the application of tableaux rules), the presence of the edge can force new information to flow to its source node or target node. This may happen through one of two mechanisms:

(1) The presence in the source node of a universal restriction ( . . . R. C) on a role R which is a super-role of the role labeling the edge. In this case, the role may play an important role during reasoning since it may be the channel through which the concept C may be propagated to its target node. (Note that with inverse role, information propagation may occur in the opposite direction: from the target to the source).

(2) The presence in the source node of a maximum cardinality restriction ([nR) may propagate new information to the target node through its merger with one or more of its siblings.

Definition: Given a TBox T and a RBox R, a role P is not involved in any universal restrictions iff there is no sub-concept . . . S. C of a concept in T such that P is a sub-role of S.

Definition: Given a TBox T and a RBox R, a role P is not involved in a maximum cardinality restriction iff there is no sub-concept [n S of a concept in T such that P is a sub-role of S.

Definition: Similar definitions for minimum cardinality and existential restriction.

Definition: Given a TBox T and a RBox R, a role P is not involved in any restrictions iff it is not involved in any universal or existential restrictions, any maximum or minimum cardinality restriction.

Irrelevant and inverse-relevant roles:

(1) (Lemma A) A role R not involved in any restrictions and whose inverse, if defined, is also not involved in any restrictions is irrelevant. All edges labeled R in the ABox can safely be removed.

(2) (Lemma B): A role R whose inverse and itself are not involved in any universal restrictions and in any maximum cardinality restrictions is irrelevant (Note: cardinality restriction is translated into a maximum and minimum cardinality restriction with the same value constraint). All edges labeled R in the ABox can safely be removed.

(3) A role R not involved in any universal restrictions and in any maximum cardinality restrictions, but whose inverse is involved in such restrictions is inverse-relevant. All edges labeled R in the ABox cannot safely be removed just based on a T Box analysis.

ABox Analyses

Here we describe static analyses that take into account the particular structure of an ABox in order to remove irrelevant edges. Two types of analyses are described:

(1) Direct neighborhood analyses assume, very conservatively, that, during the tableaux expansion, all sub-expressions of concepts appearing in the ABox can reach any individual in the ABox. So in order to understand the effects of a particular edge only the direct neighbors of its source and target nodes need to be considered. These analyses are not expensive to perform, but in some cases can lead to very approximate results.

(2) Concept flow analyses attempt to provide for a given individual a much better approximation of the concepts that can reach it during the tableaux expansion. This information can then be used to further prune edges.

Direct Neighborhood Analyses

A better analysis of universal restrictions:

(1) (Lemma C) Let R be a role involved in n universal restrictions . . . R1.A1, . . . , . . . Rn.An and not involved in any maximum cardinality restrictions such that its inverse, if defined, is not involved in any universal restrictions and any maximum cardinality restrictions. In the ABox, an edge labeled R whose target node is explicitly asserted as being an instance of concepts T1, . . . , Tp can safely be removed if the following condition holds:
for all r in {1, . . . , n} there is k in {1, . . . , p} such that Tk is obviously subsumed1 by Ar. This condition guarantees that, during the tableaux rule application, no new information (information that cannot be found otherwise) will be propagated to the target from source through the R edge.
for all S such that R β S, S is not a transitive role

(2) (Lemma D) Let R be a role involved in n universal restrictions . . . R1.A1, . . . , . . . Rn.An and whose inverse R′ is defined and is involved in m universal restrictions . . . R′1.B1 . . . , . . . R′m.Bm. Furthermore, both R and R′ are not involved in any maximum cardinality restrictions. In the ABox, an edge labeled R whose target node is explicitly asserted to be an instance of concepts T1, . . . , Tp and whose source node is explicitly asserted to be an instance of concepts S1 . . . ,Sq can safely be removed if the following conditions hold:
For all r in {1, . . . , n} there is k in {1, . . . , p} such that Tk is obviously subsumed by Ar.
For all S such that R β S, S is not a transitive role
For all r in {1, . . . , m} there is k in {1, . . . , q} such that Sk is obviously subsumed by Br.
For all S such that inv(R) β S, S is not a transitive role

These conditions guarantee that, during the tableaux rule application, no new information will be propagated to the target from source through the R edge or from the target to the source through the R edge as a consequence of a universal restriction on R′.

Analyzing Maximum Cardinality Restrictions

In the description above, no rules deal with roles involved in maximum cardinality restrictions. The static analysis of these roles is hard because of the ripple effect of mergers: if two nodes are merged, the number of edges of the merged node may increase, which can then lead to more mergers. Furthermore, these subsequent mergers can involve edges labeled with a role complete unrelated to the role label of the edges involved in the first merger. A simple static analysis of maximum cardinality can only be achieved when we can show that the ABox is such that neighbors of real individuals present in the ABox can never be merged.

Let R be a role involved in the maximum cardinality restriction [nR. During the tableaux expansion, two R-neighbors of a node N can be merged because of [nR only if at some point during the tableaux expansion N has more than n R-neighbors and [nR is in its list of concepts. In order to guarantee that no mergers can involve neighbors of real individuals in the ABox, we find an upper bound of the number of R-neighbors of all ABox individuals before the first merger involving neighbors of a real individual in the ABox (assuming that such merger happens). If this upper bound is less or equal to the maximum cardinality value for all R roles involved in maximum cardinality restrictions, no mergers involving individuals will ever occur. Therefore, an edge labeled R that was not removed by analyses described in previous sections because of the maximum cardinality on R can now safely be removed.

Upper Bound on the Number of R-Neighbors

During the tableaux expansion, there are three kinds of R-neighbors of an individual i:

(1) Individuals i′ in the ABox such that P(i, i′) (explicit R-successors) such that P β R

(2) Individuals i″ in the ABox such that P′(i″, i), where P′ is the inverse of P and P β R

(3) Pseudo-individuals psi that were not initially present in the ABox, but were generated by the application of the tableaux rules.

The number of individuals of type (1) and (2) can easily be obtained from the ABox. Since we assumed that nominals are not allowed, it follows that R-neighbors of type (3), before any mergers have occurred, can only be R-successors of i. Such individuals can be generated in two ways:

1. from rules that handle the presence in the list of concepts associated with i of a) existential restrictions involving sub-roles of R or b) minimum cardinality restriction involving sub-roles of R (note that a minimum cardinality that is incompatible with the maximum cardinality on the role R being considered can be ignored since, if both the minimum and maximum cardinality restrictions could reach i, they would lead to a clash in i. Therefore mergers between R-neighbors of i would not occur since the [-rule for [nR would never be applied to i), or

2. from mergers between i and a child y of a pseudo individual x, such that x is a child of i as shown in FIG. 1. Furthermore, x was created by a generator (|TC or μmT) such that that T is not a sub-role of R. Such mergers can make x a R-neighbor of i if the inverse of the set of role labels for the edge (x, y) contains a sub-role of R.

The upper bound on the number of pseudo-individuals c of type 1 (pseudo-individuals generated by a generator whose role is a sub-role of R) child of the real individual i. when considering possible mergers due to a maximum cardinality restriction [nR in i is as follows:
card({|P.A χ clos(A)|P β R and there is no ii χ Neighbor₀(i, P) s.t. B χ L₀(ii) and B is obviously subsumed by A})+Sum((m|μmP χ clos(A) and P β R and nμm))

where
clos(A) is the set of concepts that can appear in node labels during tableau. (the formal definition of clos(A) is given in Appendix A incorporated herein by reference)
Lₖ(s) is the concept set associated with the individual s at the kth step of the tableau expansion algorithm
Neighborₖ(i, P) is the set of P-neighbors of the individual i at the kth step of the tableau algorithm

The upper bound on the number of pseudo-individuals x of type 2 (pseudo-individuals generated by a generator whose role is not a sub-role of R) child of the real individual i. when considering possible mergers due to a maximum cardinality restriction [nR in i is as follows:
card({|T.A∥T.A χ clos(A) and not(T β R) and strict-d-attract(inv(T)) γ [symbol] and S χ loose-attract(T) and S β R and there is no ii χ Neighbor₀(i, T) s.t. B χ L₀(ii) and B is obviously subsumed by A}+Sum(m|μm T χ clos(A) and not(T β R) and strict-d-attract(inv(T)) γ{ } and S χ loose-attract(T) and S β R)

where
strict-d-attract(P)={S|{P, S} gen(clos(A)) and [n T χ clos(A) s.t. S β T and P β T}. Informally, S is an element of strict-d-attract(P) iff generators of P and S are in the TBox and there is a max cardinality restriction on T that can force the merger of a P-neighbor and a Q-neighbor. By the definition of a pseudo-individual of type 2 generated by a generator whose role is T, strict-d-attract(inv(T)) cannot be empty (otherwise the pseudo individual y child of x cannot be merged with the real individual i).
gen(ConceptSet)={Q∥Q.A χ ConceptSet or μm Q χ ConceptSet}
loose-attract(P)=loose-d-attract(P) 4 {Q|there is S such that Q χ loose-d-attract(S) and S χ loose-attract (P)}. loose-attract is a conservative version of the transitive closure of strict-d-attract (a role P and its inverse inv(P) are treated the same way).
loose-d-attract(P)={Q|(P χ gen(clos(A)) or inv(P) χ gen(clos(A))) and (Q χ gen(clos(A)) or inv(Q) χ gen(clos(A))) and [n T χ clos(A) s.t. (Q β T and P β T) or (inv(Q) β T and P β T) or (Q β T and inv(P) β T) or (inv(Q) β T and inv(P) β T)}. Intuitively, loose-d-attract(P) is the union of strict-d-attract(P) with all the inverses of roles in strict-d-attract(P). Loose-d-attract therefore takes the conservative approximation here by taking roles and their inverses into account.

Lemma E:

For a real individual i of an ABox A (i.e. an individual present in A before the application of any tableau rule), at step k of the tableau algorithm before the first merger of neighbors of a real individual, the set Neighborₖ^{b}(i, R) of R-neighbors of i for a clash-free branch b of the non-deterministic tableau algorithm is such that:

if [n R χ Lₖ(i), then card(Neighborₖ^{b} (i, R)) [card(Neighbor₀ (i, R))+card({|P.A χ clos(A)|P β R and there is no ii χ Neighbor₀(i, P) s.t. B χ L₀(ii) and B is obviously subsumed by A})+Sum((m|μmP χ clos(A) and P β R and nμm))+card({|T.A∥T.A χ clos(A) and not(T β R) and strict-d-attract(inv(T)) γ{ } and S χ loose-attract(T) and S β R and there is no ii χ Neighbor₀(i, T) s.t. B χ L₀(ii) and B is obviously subsumed by A}+Sum(m|μm T χ clos(A) and not(T β R) and strict-d-attract(inv(T)) γ{ } and S χ loose-attract(T) and S β R)

Lemma F:

For an ABox A, if for all [nR χ clos(A), for real individual i in A, the following condition holds:

card(Neighbor₀ (i, R))+card({|P.A χ clos(A)|P β R and there is no ii χ Neighbor₀(i, P) s.t. B χ L₀(ii) and B is obviously subsumed by A})+Sum((m|μmP χ clos(A) and P β R and nμm))+card({|T.A∥T.A χ clos(A) and not(T β R) and strict-d-attract(inv(T)) γ{ } and S χ loose-attract(T) and S β R and there is no ii χ Neighbor₀(i, T) s.t. B χ L₀(ii) and B is obviously subsumed by A}+Sum(m|μm T χ clos(A) and not(T β R) and strict-d-attract(inv(T)) γ{ } and S χ loose-attract(T) and S β R) [n

then, during the tableau algorithm, no mergers between neighbors of real individuals can occur.

Theorem:

For an ABox A, if for all [nR χ clos(A), for real individual i in A, the following condition holds:

card(Neighbor₀ (i, R))+card(({|P.A χ clos(A)|P β R and there is no ii χ Neighbor₀(i, P) s.t. B χ L₀(ii) and B is obviously subsumed by A})+Sum((m|μmP χ clos(A) and P β R and nμm))+card({|T.A∥T.A χ clos(A) and not(T β R) and strict-d-attract(inv(T)) γ{ } and S X loose-attract(T) and S β R and there is no ii χ Neighbor₀(i, T) s.t. B χ L₀(ii) and B is obviously subsumed by A}+Sum(m|μm T χ clos(A) and not(T β R) and strict-d-attract(inv(T)) γ{ } and S χ loose-attract(T) and S β R) [n

then all edges of A label with a role not involved in any universal cardinality restrictions and whose inverse is not involved in any universal cardinality restrictions can be safely removed from A

Concept Flow Analyses

During the tableaux expansion rules, a sequence of a boxes (A=A0, A1, . . . , An) are produced until a clash is found or a complete ABox An is produced. The goals of the concept flow analysis are as follows:

(1) Find an upper bound of the set of concepts that can flow to a given individual present in the initial ABox A. In other words, we need to build a function ML such that for each individual i in the initial ABox A, and for all k in {0, . . . ,n} Lk(i) M̅L(i) (where Lk(i) is the set of concepts associated with individual i at the kth tableaux rule application)

(2) Find an upper bound of the number of neighbork(s, S), where s is an individual in A and neighbork(s, S)={t|(R(s, t) χ Ak or R′(t, s) χ Ak with R′=inv(R)) and R βS}. In other words, we need to build a function MNeighbor such that for each individual i in the initial ABox A, for all k in {0, . . . , n} card(neighbork (i, S)) [MNeighbor (i, S)

The control flow analysis gives us (1) a better understanding of the concept that may reach a given individual and (2) a conservative upper bound on the number of neighbors of a given individual. These two pieces of information allow us to remove edges that were kept on the assumption, now invalidated, that certain concepts may reach certain individuals or that certain individuals may be merged.

Performing a control flow analysis on the original ABox may be very expensive if it does not fit in main memory. The analysis is performed on a summary of the original ABox. This ABox summary captures the general structure or schema of the ABox. The notion of ABox reduction formalizes the idea of ABox summary.

ABox Reduction Definitions

Definition: A labeled graph is a tuple (V, E, VLab, ELab, v1) where

(1) V is a finite set of nodes,

(2) VLab is a finite set of labels for nodes,

(3) ELab is a finite set of labels for edges,

(4) E, a subset of V*ELab*V, is a ternary relation describing the edges (including the labeling of the edges),

(5) v1 is a complete function from V to VLab describing the labeling of the nodes and

Definition: A generalized SHIN-ABox graph is a labeled graph G=(V, E, 2ˆCon, Roles, v1) such that

(1) labels of vertices are subsets of a finite set Con of SHIN Concepts in the negation normal form NNF. Furthermore, clos(Con)=Con. The formal definition of clos is given in the Appendix A. Intuitively, Con is the set of concepts that can appear during the tableaux expansion of an Abox whose set of Thox concept is a subset of Con.

(2) The set of edge labels, Roles, consists of SHIN roles and there is a partial order relation β on Roles.

Notation:
neighbor(s, S, E)={t|there is R such that (s, R, t) χ E and R β S} 4 {t|there is R′ such that (t, R′, s) χ E and R′ is the inverse of a role R such that R β S}
t is a S-neighbor(E) of s iff t χ neighbor(s, S, E)

Definition: A generalized SHIN-ABox graph reduction.

Given two generalized SHIN-ABox graphs G=(V, E, 2ˆC, Roles, v1) and G′=(V′, E′, 2ˆC′, Roles′, v1′), a complete function f from V to V′ is a reduction from G to G′ iff all of the following hold:

(1) f(V)=V′

(2) C′=C and Roles′=Roles

(3) For all v χ V, v1(v) v̅1′(f(v))

(4) For all v1 and v2 χ V and R χ Roles, if (v1, R, v2) is in E then (f(v1), R, f(v2)) is in E′

Notation:

(1) For a concept in NNF C, clos(C) is formally defined in the Appendix A.

(2) For a SHIN-ABox A, clos(A) is formally defined in the Appendix A. It includes Union(clos(C) such that a:C χ A)

Definition: Canonical generalized SHIN-ABox graph of a SHIN ABox.

Given a SHIN-Abox A together with its TBox T and RBox R, its unique canonical generalized SHIN-ABox graph G=(V, E, 2ˆclos(A), Roles, v1) is defined as follows:

(1) V is the set of individual in the SHIN Abox A

(2) Roles is the set of roles defined in the RBox together with their inverse (3)

For all v1, v2 χ V and R χ Roles, (v1, R, v2) χ E iff R(v1, v2) is in the ABox

(4) For v χ V, v1(v)={C|v:C is in the ABox A}

The idea of summary graph of an ABox A is captured by the reduction the canonical generalized SHIN-ABox graph of A.

Definition: The ABox A corresponding to a generalized SHIN-ABox graph G=(V, Ed, 2^{concepts}, Roles, v1) and having all the equalities and inequalities derived from a set ES by a function f whose domain is a superset of V is the ABox with the following assertions {x: C|x χ V and C χ v1(x)} 4 {P(x, y)|P χ Roles and (x, P, y) χ E} 4 {same(f(x), f(y))|same(x, y) χ ES) 4 {different(f(x), f(y))|different(x, y) χ ES}. Note that clos(A) clos(concepts) (=concepts, by definition of SHIN-ABox graph)

Theorem 1: Let G=(V, Ed, 2^{clos(A)}, Roles, v1) be the canonical generalized SHIN-ABox graph of a SHIN Abox A, and let f be a reduction from G to G′=(V′, Ed′, 2^{concepts′}, Roles′, v1′), then

If the ABox A′, which corresponds to G′ and has all the equalities and inequalities derived from the set of equality and inequality assertions defined in A by f, is consistent then A is consistent.

The following algorithm performs the flow analysis.

Analysis Algorithm

Input: G0=(V0, E0, 2ˆCon, Roles, v10) a generalized SHIN ABox graph G0 md=maximum depth of the completion trees (an integer greater or equal to 1)

Output: A pair (G, h) such that:

a. G=(V=V′4 V″, E=E′ 4 E″, 2ˆCon, Roles, v1) is a weighted labeled graph

and b. h is a complete function from V0 to V

Initialization:

a. G->(V=V′ 4 V″, E=E′ 4 E″, 2ˆCon, Roles, v1)

(Note: E″ will have edges between two pseudo individuals, and edges between a real individual and a pseudo-individual. V″ will have all the pseudo-individuals introduced by the algorithm)

b. V′->V0; V″-->{ }; E′-->E0; E″-->{ }; v1-->v10

c. For all v χ V′, initial (v)-->{v} (initial(x) keeps track of all the nodes that have been merged in x)

d. For all v χ V′, depth(v)-->0 (corresponds to the depth of a node in the completion tree)

e. blocked-->{ } (corresponds to the set of blocked pseudo-nodes. A pseudo-individual is blocked if it cannot influence its ancestors or be merged with a none-blocked node)

f. stopped-->{ } (a node is stopped, if its descendants and itself will never be considered)

g. parent function maps pseudo individual to their parent in the completion tree

h. anc-or-self is the reflexive transitive closure of parent

Apply the following rules until no one can be applied:

(1) If

a. s ω̅ blocked and anc-or-self(s) 3 stopped= [symbol] , and

b. C1 6 C1 χ v1(s), and

c. {C1, C2} is not included in v1(s)

then v1(s)-->v1(s) 4 {C1, C2}

(2) if

a. s ω̅ blocked and anc-or-self(s) 3 stopped= [symbol] , and

b. C1 7 C2 χ v1(s), and

c. {C1, C2} is not included in v1(s)

then v1(s)-->v1(s) 4 {C1, C2}

(3) if

a. s ω̅ blocked and anc-or-self(s) 3 stopped= [symbol] , and

b. . . . S.C χ v1(s), and

c. there is an S-neighbor(E) t of s with C ω̅ v1(t), and

d. t ω̅ blocked

then v1(t)-->v1(t) 4 {C}

(4) if

a. s ω̅ blocked and anc-or-self(s) 3 stopped= [symbol] , and

b . . . . S.C χ v1(s), and

c. there is some transitive role R and Rβ S, and

d. there is a R-neighbor(E) t of s such that . . . R.C ω̅ v1(t), and

e. t ω̅ blocked

then v1(t)-->v1(t) 4 { . . . R.C}

(5) if

a. s ω̅ blocked and anc-or-self(s) 3 stopped=< [symbol] , and

b. |S.C χ v1(s), and

c. there is no t S-neighbor(E) of s such that C χ v1(t), and

d. depth(s)<md

then

a. create a new node t in V″ (i.e V″-->V″ 4 {t}), and

b. E″-->E″ 4 {(s, S, t)}, and

c. E-->E′ 4 E″, and

d. v1(t)-->{C}, and

e. depth(t)-->depth(s)+1

f. parent(t)-->s

g. if (!childMayBeMergedWithNoneBlockedIndiv(s, S) and !childMayInfluenceAnc(s, S) then blocked-->blocked 4 {t}

(Note the formal specifications of childMayBeMergedWithNoneBlockedIndiv and childMayInfluenceAnc are given after the this set of “static tableau rules”)

(6) if

a. s ω̅ blocked and anc-or-self(s) 3 stopped= [symbol] , and

b. μ n S χ v1(s), and

c. there is no S-neighbor(E) of s, and

d. depth(s)<md

then

a. create a new node t in V″ (i.e V″-->V″ 4 {t}), and

b. E″-->E″ 4 {(s, S, t)}, and

c. E-->E″ 4 E″, and

d. depth(t)-->depth(s)+1

e. parent(t)-->s

f. if (!childMayBeMergedWithNoneBlockedIndiv(s, S) and !childMayInfluenceAnc(s, S)) then blocked-->blocked 4 {t}

(7) if

a. s ω̅ blocked and anc-or-self(s) 3 stopped= [symbol] , and

b. [n S χ v1(s), and

c. card(neighbor(s, S, E))>1, and

d. depth(s)<md

then

a. N-->neighbor(s, S, E)

b. choose x in N. if N has real individuals, x must be a real individual (i.e. depth(x)=0). If N has a parent of s, then x must be chosen among the parents of s. (Note that if N has at least one real individual and at least one parent of s, then all parents of s present in N are also real individuals. A real individual i is the parent of a real individual ii iff there is R such that (i, R, ii) χ E)

c. initial(x)-->Union(initial(y)|y χ N)

d. v1(x)-->Union(v1(y)|y χ N)

e. stopped-->stopped 4 {y|y χ N and y γ x}

f. A′-->{(t, R, y)|(t, R, y) χ E′ and y χ N−{x}} 4 {(y, R, t)|(y, R, t) χ E′ and y χ N−{x} and depth(y)=0})

g. E′-->(E′−A′)

4 {(x, inv(R), t)|(t, R, y) χ E′ and y χ N−{x} and (depth(y)>0 and x χ anc-or-self(y))}

4 {(t, R, x)|(t, R, y) χ E′ and y χ N−{x} and (depth(y)=0 or x ω̅ anc-or-self(y))}

4 {(x, R, t)|(y, R, t) χ E′ and y χ N−{x} and depth(y)=0}

(Note that. for the second set, t=s because, since y is pseudo-individual, y has a single parent)

h. A″-->{(t, R, y)|(t, R, y) χ E″ and y χ N−{x}} 4 {(y, R, t)|(y, R, t) χ E″ and y χ N−{x} and depth(y)=0})

i. E″-->(E″−A″)

4 {(x, inv(R), t)|(t, R, y) χ E″ and y χ N−{x} and (depth(y)>0 and x χ anc-or-self(y))}

4 {(t, R, x)|(t, R, y) χ E″ and y χ N−{x} and (depth(y)=0 or x χ anc-or-self(y))}

4 {(x, R, t)|(y, R, t) χ E″ and y χ N−{x} and depth(y)=0}

j. E-->E′ 4 E″

(8) If

a. s ω̅ blocked and anc-or-self(s) 3 stopped= [symbol] , and

b. (depth(s)=md) or (depth(s)=md−1), and

c. clos(v1(s)) is not included in v1(s),

then

a. v1(s)-->clos(v1(s))

Note: this rule ensures that when we reach the maximum depth (i.e. the tree expansion stops), we have a correct conservative approximation of the upper-bound of the concept set of s. This also needs to be applied at level md−1 to compensate for the second effect of [-rule.

(9) If

a. s ω̅ blocked and anc-or-self(s) 3 stopped= [symbol] , and

b. depth(s)=md−1, and

c. there is x χ neighbor(s, E) and x ω̅ blocked and depth(x)=md, and

d. a role Q such that Q χ gen(v1(x)) 4 inv(gen(v1(x))) and (s, inv(Q),x) ω̅ E

then

a. E″-->E″ 4 {(s, inv(Q),x)}, and

b. E-->E′ 4 E″

Note: This rule takes into account the second effect of [-rule when the maximum depth is reached in the children of s. Without this rule, we may not include in the set of edge labels between s and its children, additional labels coming from the second effect of [-rule.

(10) if

a. s ω̅ blocked and anc-or-self(s) 3 stopped= [symbol] , and

b. there is a S-neighbor(E) of s, and

c. the domain of S is specified, and

d. domain(S) ω̅ v1(s)

then v1(s)-->v1(s) 4 {domain(S)}

(11) if

a. s ω̅ blocked and anc-or-self(s) 3 stopped= [symbol] , and

b. there is a S-neighbor(E) of s, and

c. S is a functional role, and

d. [1S ω̅ v1(s)

then v1(s)-->v1(s) 4 {[1S}

(12) if a. s ω̅ blocked and anc-or-self(s) 3 stopped= [symbol] , and

b. t is a S-neighbor(E) of s, and

c. t ω̅ blocked, and

d. the range of S is specified, and

e. range(S) ω̅ v1(t)

then v1(t)-->v1(t) 4 {range(S)}

(13) if

a. s ω̅ blocked and anc-or-self(s) 3 stopped= [symbol] , and

b. C β D is in the unfoldable component of the TBox, and

c. C χ v1(s) and D ω̅ v1(s)

then v1(s)-->v1(s) 4 {D}

(Lazy Unfolding Rule)

(14) If

a. s ω̅ blocked and anc-or-self(s) 3 stopped= [symbol] , and

b. C η D is in the unfoldable component of the TBox, and

c. C χ v1(s) and D ω̅ v1(s)

then v1(s)-->v1(s) 4 {D}

(Lazy Unfolding Rule)

(15) If

a. s ω̅ blocked and anc-or-self(s) 3 stopped= [symbol] , and

b. C η D is in the unfoldable component of the TBox, and

c. −C χ v1(s) and −D ω̅ v1(s)

then v1(s)-->v1(s) 4 {−D}

(Lazy Unfolding Rule)

(16) if a. s ω̅ blocked and anc-or-self(s) 3 stopped= [symbol] , and

b. UC !=null (i.e. Tg. is not empty)

c. UC ω̅ v1(s)

then v1(s)-->v1(s) 4 {UC}

(17) if

a. s χ blocked and anc-or-self(s) 3 stopped= [symbol] , and

b. there is S such that s is a S-neighbor of parent(s) (note since only pseudo-individual can be blocked, parent(s) is well defined), and

c. childMayBeMergedWithNoneBlockedIndiv(parent(s), S) or childMayInfluenceAnc(parent(s), S)

then blocked-->blocked−{s}

(note that once a pseudo-individual has been unblocked, it will remain unblocked until the ed of the execution)

This is a simple unblocking mechanism such that once a node is unblocked, it will remain unblocked until the completion of the algorithm.

Finalization:

a. For all v χ V0, h(v)-->x such that v χ initial(x) and x ω̅ stopped (Note: In appendix, Lemma I establishes that x exists and is unique)

childMayBeMergedWithNoneBlockedIndiv(Node s, Role S)

Return true iff there is a R-neighbor t of s such that

a. t ω̅ blocked, and

b. there is [n T χ v1(s), and

c. S β T and Rβ T

childMayInfluenceAnc(s, S)

If there is no T such that S β T and inverse of T is defined

return false

If Following Two Conditions Hold

1. there is no T such

a. S β T, and

b. there is a . . . Q.C χ clos(A) such that inv(T) β Q

2. strict-d-attract(inv(S))={ }

return false

otherwise return true

Theorem 2:

Let A be SHIN ABox, let GA be its canonical generalized SHIN-ABox graph GA, let G0 be a generalized SHIN-ABox graph G0 and g0 a reduction from GA to G0, let (G, h) such that (G=(V, E=E′ 4 E″, 2ˆCon, Roles, v1), h)=AnalysisAlgorithm(G0), let (A0=A, A1, . . . , An) a sequence of SHIN ABoxes derived from the application of the tableaux expansion rules to A, for all k×{0, . . . , n}, for all i χ A0: Lk(i) v1(h(g0(i))), where Lk (i) is the label associated with i in the Abox Ak.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. An apparatus comprising:
an import module;
a scope definition module;
a query processing component;
a storage manager;
a reasoning engine; and
a data store.

2. The apparatus of claim 1 wherein the import module enables an import of Ontology Documents into a persistent store that a reasoner relies on for data.

3. The apparatus of claim 1 wherein the scope definition module enables a user to specify a sub-part of an ontology.

4. The apparatus of claim 1 wherein the query processing component enables a parsing of queries expressed in SPARQL, a standardized query language for resource description framework (RDF) data.

5. The apparatus of claim 1 wherein the storage manager enables create, read, update, delete (CRUD) plus passing through reasoning functions

6. The apparatus of claim 1 wherein the reasoning engine comprises:
a taxonomy builder that infers implicit subclass and equivalence relationships between concept;
a consistency detection component that discovers any inconsistencies in an ontology;
a relationship query component that answers questions about a relationship between ABox instances; and
a membership query component that answers queries about types of various individuals.

7. The apparatus of claim 1 wherein the data store is a RDF store.

8. A computer-implemented method of generating a simplified ontology comprising:
loading an ontology from a store;
eliminating relationships in the ontology, the eliminating relationships including an insertion of new relationships that simplify the ontology;
eliminating individuals in the ontology, the eliminating individuals including insertion of new individuals to simplify the ontology;
eliminating concepts in the ontology including insertion of new concepts to simplify the ontology, and
generating the simplified ontology from the eliminating relationships, eliminating individuals and eliminating concepts.

9. The computer-implemented method of claim 8 further comprising reasoning over the simplified ontology instead of the original ontology.

10. The computer-implemented method of claim 8 further comprising generating an explanation to a user of how a specific inference was made by an ontology reasoner.

11. The computer-implemented method of claim 8 further comprising compressing the ontology with the simplified ontology.

12. The computer-implemented method of claim 8 wherein the simplified ontology tracks changes in the ontology, such that updates to the ontology do not require re-generation of the simplified ontology.

13. The computer-implemented method of claim 8 wherein the ontology comprises OWL Web Ontology Language documents, and any derivatives thereof which are used to express ontologies.

14. The computer-implemented method of claim 8 further comprising:
receiving a query; and
determining a response to the query in conjunction with the simplified ontology.

15. A computer program product, tangibly embodied in an information carrier, for generating a simplified ontology, the computer program product being operable to cause data processing apparatus to:
load an ontology from a store;
eliminate relationships in the ontology, the eliminating relationships including an insertion of new relationships that simplify the ontology;
eliminate individuals in the ontology, the eliminating individuals including insertion of new individuals to simplify the ontology;
eliminate concepts in the ontology including insertion of new concepts to summarized the ontology; and
generate the simplified ontology from the eliminating relationships, eliminating individuals and eliminating concepts.

16. The computer program product of claim 14 further operable to cause data processing apparatus to:
reason over the simplified ontology instead of the original ontology.

17. The computer program product of claim 14 further operable to cause data processing apparatus to:
generate an explanation to a user of how a specific inference was made by an ontology reasoner.

18. The computer program product of claim 14 further operable to cause data processing apparatus to:
compress the ontology with the simplified ontology.

19. The computer program product of claim 16 wherein the compressed ontology tracks changes in the ontology, such that updates to the ontology do not require re-generation of the simplified ontology.

20. The computer program product of claim 14 wherein the ontology comprises OWL Web Ontology Language documents, and any derivatives thereof which are used to express ontologies.

21. The computer-implemented method of claim 14 further operable to cause data processing apparatus to:
receive a query; and
determine a response to the query in conjunction with the simplified ontology.
